(19) United States
(12) Patent Application Publication
(10) Pub. No.: US 2013/0147908 A1
(43) Pub. Date: Jun. 13, 2013

(54) ELECTRONIC DEVICE AND METHOD OF CAPTURING PANORAMIC IMAGES USING THE ELECTRONIC DEVICE

(71) Applicants: CHIH-YU WEI, Shindian (TW); CHENG-HSUN LI, Shindian (TW)

(72) Inventors: CHIH-YU WEI, Shindian (TW); CHENG-HSUN LI, Shindian (TW)

(73) Assignee: FIH (HONG KONG) LIMITED, Kowloon (HK)

(21) Appl. No.: 13/609,645

(22) Filed: Sep. 11, 2012

(30) Foreign Application Priority Data
Dec. 13, 2011 (TW) 100146071

(51) Int. Cl. H04N 5/225

(52) U.S. Cl. 348/36; 348/E05.024

(57) ABSTRACT

A method of capturing panoramic images using an electronic device, a movement direction and a reference height of the electronic device are set. The electronic device is positioned to a reference position where the electronic device is at a horizontal level and at the reference height. The electronic device captures an image as a reference image. The electronic device moves from the reference position in the movement direction while keeping the horizontal level and the reference height. A media image with an overlap area of a specified size with the reference image is captured. A next reference image is captured according to the media image. All of the reference images are joined to generate a panoramic image.

### BACKGROUND

1. Technical Field

The embodiments of the present disclosure relate to systems and methods for capturing images, and particularly to an electronic device and method of capturing panoramic images using the electronic device.

2. Description of Related Art

A user may manually capture multiple images with slightly overlapping fields of view using a camera and join the images to make a panoramic image. However, if the overlapping fields are not distinct or do not exist for certain reasons (e.g., due to the user shaking the camera), the user may fail to generate the panoramic image.

### BRIEF DESCRIPTION OF THE DRAWINGS

FIG. 1 is a block diagram of one embodiment of an electronic device including a panoramic image capturing system.

FIG. 2 is a block diagram of one embodiment of function modules of the panoramic image capturing system in FIG. 1.

FIG. 3 is a flowchart of one embodiment of a method of capturing panoramic images using the electronic device in FIG. 1.

FIG. 4 is one embodiment illustrating a reference image, a media image, and a media region.

FIG. 5 is one embodiment illustrating joining two reference images.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

In the present disclosure, the word “module,” as used herein, refers to logic embodied in hardware or firmware, or to a collection of software instructions, written in a programming language. In one embodiment, the programming language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage system. Some non-limiting examples of a non-transitory computer-readable medium include CDs, DVDs, flash memory, and hard disk drives.

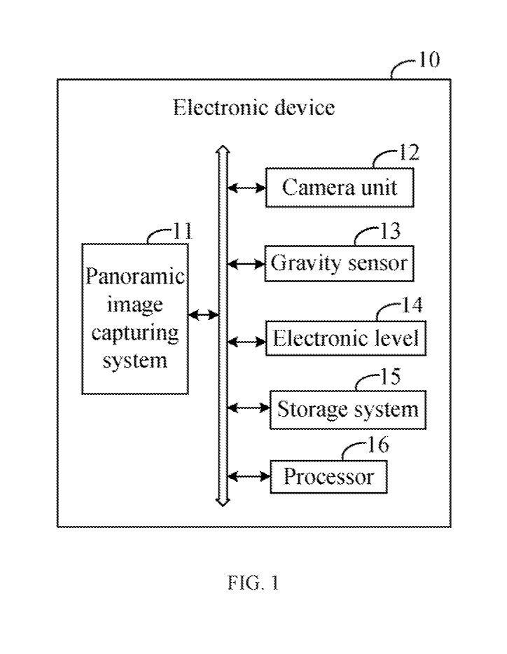

FIG. 1 is a block diagram of one embodiment of an electronic device 10. The electronic device 10 includes a panoramic image capturing system 11, a camera unit 12, a gravity sensor 13, and an electronic level 14. The gravity sensor 13 detects vertical displacements of the electronic device 10. The electronic level 14 detects whether the electronic device 10 is at a horizontal level.

The electronic device 10 may further include a storage system 15 and at least one processor 16. The storage system 15 may be a dedicated memory, such as an erasable programmable read only memory (EPROM), a hard disk drive (HDD), or flash memory. In some embodiments, the storage system 15 may also be an external storage device, such as an external hard disk, a storage card, or other data storage medium.

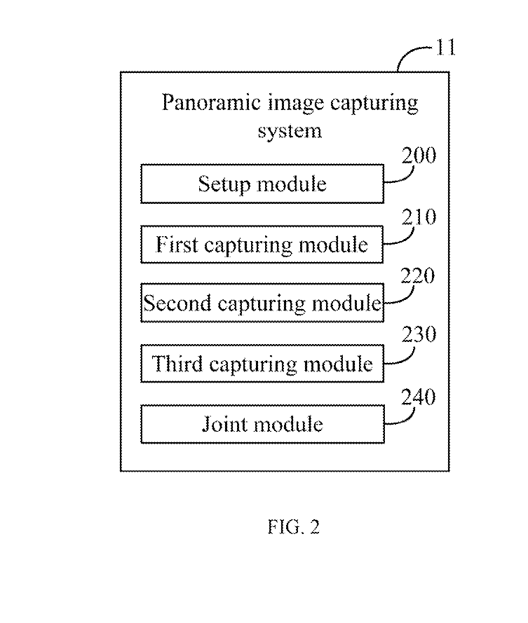

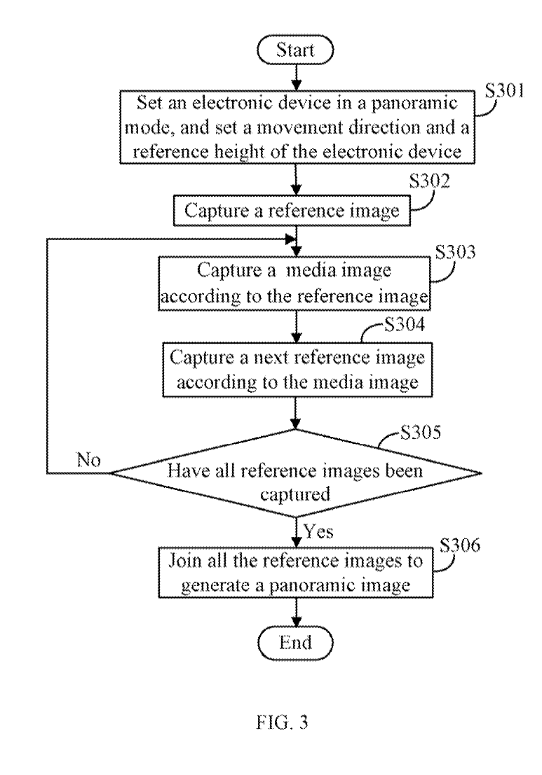

FIG. 2 is a block diagram of one embodiment of function modules of the panoramic image capturing system 11 shown in FIG. 1. The panoramic image capturing system 11 includes a setup module 200, a first capturing module 210, a second capturing module 220, a third capturing module 230, and a joint module 240. The modules 200-240 may comprise computerized code in the form of one or more programs that are stored in the storage system 15. The computerized code includes instructions that are executed by the at least one processor 16, to provide the aforementioned functions of the panoramic image capturing system 11. A detailed description of the functions of the modules 200-240 is given below in reference to FIG. 3.

FIG. 3 is a flowchart of one embodiment of a method of capturing panoramic images using the electronic device 10 in FIG. 1. Depending on the embodiment, additional steps may be added, others removed, and the ordering of the steps may be changed.

In step S301, the setup module 200 sets the electronic device 10 in a panoramic mode, and sets a movement direction and a reference height of the electronic device 10. When the electronic device 10 is in the panoramic mode, the electronic device 10 can capture panoramic images of a target object using the camera unit 12. The movement direction may be leftwards or rightwards. The electronic device 10 is controlled to move in the movement direction while capturing the panoramic images. The reference height may be a current height of the electronic device 10.

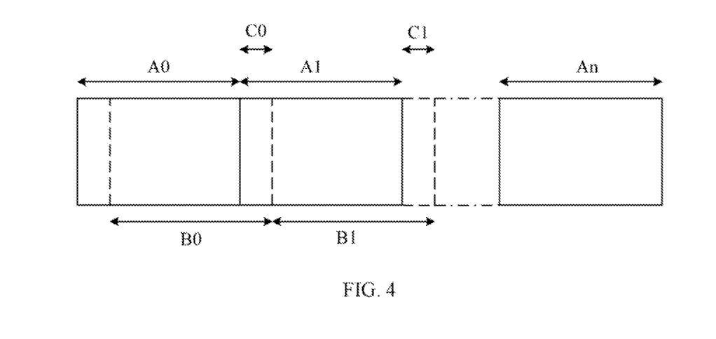

In step S302, the first capturing module 210 uses the gravity sensor 13 and the electronic level 14 to position the electronic device 10 to a reference position where the electronic device 10 is at a horizontal level and at the reference height. The first capturing module 210 controls the camera unit 12 to capture an image as a reference image at the reference position and stores the reference image into the storage system 15. In one example with respect to FIG. 4, “A0” is a reference image captured by the camera unit 12.

In step S303, the second capturing module 220 captures an image as a media image according to the reference image. The second capturing module 220 controls the electronic device 10 to move from the reference position in the movement direction (e.g., rightwards) while keeping the horizontal level and the reference height, using the gravity sensor 13 and the electronic level 14. The second capturing module 220 controls the camera unit 12 to capture a first group of images when the electronic device 10 is moving from the reference position, and calculates an overlap area of the reference image with each of the first group of images. The second capturing module 220 determines one image from the first group of images with an overlap area of a specified size (e.g., the overlap area of the media image is 80% of the media image) as the media image and stores the media image into the storage system 15. Furthermore, the second capturing module 220 determines a media position of the electronic device 10 where the camera unit 12 captures the media image and determines a region of the media image as a media region that is not overlapped with the reference image. In one example with respect to FIG. 4, “B0” is a media image corresponding to the reference image “A0,” “C0” is a media region of the media image “B0.”

In step S304, the third capturing module 230 captures a next reference image according to the media image. Particularly, the third capturing module 230 controls the electronic device 10 to move from the media position in the movement direction while keeping the horizontal level and the reference height, using the gravity sensor 13 and the electronic level 14. The third capturing module 230 controls the camera unit 12 to capture a second group of images when the electronic device 10 is moving from the media position, and calculates an overlap area of the media image with each of the second group of images. The third capturing module 230 determines one image from the second group of images as the media region as a next reference image and stores the next reference image into the storage system 15. The overlap area of the next reference image is same as the media region. The third capturing module 230 further determines a next reference position where the camera unit 12 captures the next reference image.

In step S305, the joint module 240 determines whether all reference images have been captured. If there are other reference images to be captured, the process returns to step S303, the second capturing module 220 captures a next media image according to the next reference image. In one embodiment, the camera unit 12 includes a shutter. The shutter is configured to be pressed to start capturing the reference images and is configured to be pressed again to stop capturing the reference images.

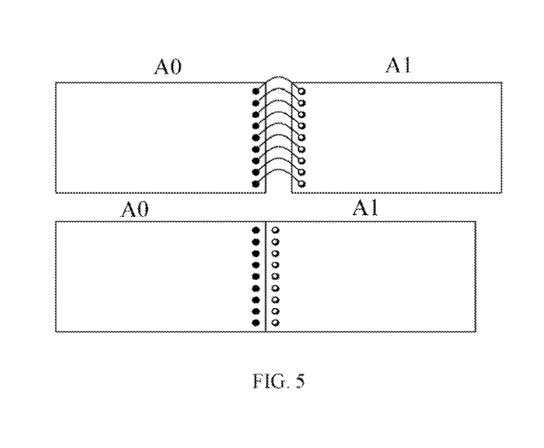

If all reference images have been captured, in step S306, the joint module 240 joins all of the reference images to generate a panoramic image according to a capture sequence of the reference images, and stores the panoramic image into the storage system 15. In one example, three reference images A0, A1, and A2 are captured sequentially. A0 is first captured and A2 is last captured. The joint module 240 joins the reference image Al to the reference A0, and then joins the reference image A2 to the reference A1. In one embodiment, the joint module 240 joins a last line of pixels of a specific reference image to a first line of pixels of a reference image next to the specific reference image. FIG. 5 illustrates one embodiment of joining two reference images (e.g., the reference images A0 and A1). As seen from FIG. 5, a last line of pixels of the reference image A0 is joined to a first line of pixels of the reference image A1.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method of capturing panoramic images being executed by a processor of an electronic device, the method comprising:
(a) setting a movement direction and a reference height of the electronic device;
(b) using a gravity sensor and an electronic level of the electronic device to position the electronic device to a reference position where the electronic device is at a horizontal level and at the reference height, controlling a camera unit of the electronic device to capture an image as a reference image at the reference position, and storing the reference image in a storage system of the electronic device;
(c) controlling the electronic device to move from the reference position in the movement direction while keeping the horizontal level and the reference height, using the gravity sensor and the electronic level, controlling the camera unit to capture a first group of images when the camera unit is moving from the reference position, determining one image as a media image from the first group of images, determining a media position of the electronic device where the camera unit captures the media image, determining a region of the media image as a media region, and storing the media image into the storage system;
(d) controlling the electronic device to move from the media position in the movement direction while keeping the horizontal level and the reference height, using the gravity sensor and the electronic level, controlling the camera unit to capture a second group of images when the camera unit is moving from the media position, determining one image from the second group of images as a next reference image, storing the next reference image into the storage system, and determining a next reference position where the camera unit captures the next reference image;
(e) repeating steps (b)-(c) upon condition that there are other reference images to be captured; and
(f) joining all reference images to generate a panoramic image according to a capture sequence of the reference images, and storing the panoramic image into the storage system.

2. The method of claim 1, wherein the overlap area of the media image is 80% of the media image.

3. The method of claim 1, wherein the camera unit comprises a shutter, wherein the shutter is configured to be pressed to start capturing the reference images and is configured to be pressed again to stop capturing the reference images.

4. The method of claim 1, wherein a last line of pixels of a specific reference image is joined to a first line of pixels of a reference image next to the specific reference image.

5. The method of claim 1, wherein the media image is with an overlap area of a specified size with the reference image, and the media region is un-overlapped with the reference image.

6. The method of claim 1, wherein the next reference image is overlapped with the media image, an overlap area of the next reference image is same as the media region.

7. An electronic device, comprising:
a gravity sensor;
an electronic level;
a camera unit;
a storage system;
at least one processor; and
a panoramic image capturing system comprising one or more programs that are stored in the storage system and executed by the at least one processor, the one or more programs comprising instructions to:
(a) set a movement direction and a reference height of the electronic device;
(b) use the gravity sensor and the electronic level to position the electronic device to a reference position where the electronic device is at a horizontal level and at the reference height, control the camera unit to capture an image as a reference image at the reference position, and store the reference image in the storage system;
(c) control the electronic device to move from the reference position in the movement direction while keeping the horizontal level and the reference height, using the gravity sensor and the electronic level, control the camera unit to capture a first group of images when the camera unit is moving from the reference position, determine one image as a media image from the first group of images, determine a media position of the electronic device where the camera unit captures the media image, determine a region of the media image as a media region, and store the media image into the storage system;
(d) control the electronic device to move from the media position in the movement direction while keeping the horizontal level and the reference height, using the gravity sensor and the electronic level, control the camera unit to capture a second group of images when the camera unit is moving from the media position, determine one image from the second group of images as a next reference image, store the next reference image into the storage system, and determine a next reference position where the camera unit captures the next reference image;
(e) repeat steps (b)-(c) upon condition that there are other reference images to be captured; and
(f) join all reference images to generate a panoramic image according to a capture sequence of the reference images, and store the panoramic image into the storage system.

8. The electronic device of claim 7, wherein the overlap area of the media image is 80% of the media image.

9. The electronic device of claim 7, wherein the camera unit comprises a shutter, wherein the shutter is configured to be pressed to start capturing the reference images and is configured to be pressed again to stop capturing the reference images.

10. The electronic device of claim 7, wherein a last line of pixels of a specific reference image is joined to a first line of pixels of a reference image next to the specific reference image.

11. The electronic device of claim 7, wherein the media image is with an overlap area of a specified size with the reference image, and the media region is un-overlapped with the reference image.

12. The electronic device of claim 7, wherein the next reference image is overlapped with the media image, an overlap area of the next reference image is same as the media region.

13. A non-transitory computer-readable storage medium storing a set of instructions, the set of instructions capable of being executed by a processor of an electronic device to implement a method of capturing panoramic images, the method comprising:
(a) setting a movement direction and a reference height of the electronic device;
(b) using a gravity sensor and an electronic level of the electronic device to position the electronic device to a reference position where the electronic device is at a horizontal level and at the reference height, controlling a camera unit of the electronic device to capture an image as a reference image at the reference position, and storing the reference image in a storage system of the electronic device;
(c) controlling the electronic device to move from the reference position in the movement direction while keeping the horizontal level and the reference height, using the gravity sensor and the electronic level, controlling the camera unit to capture a first group of images when the camera unit is moving from the reference position, determining one image as a media image from the first group of images, determining a media position of the electronic device where the camera unit captures the media image, determining a region of the media image as a media region, and storing the media image into the storage system;
(d) controlling the electronic device to move from the media position in the movement direction while keeping the horizontal level and the reference height, using the gravity sensor and the electronic level, controlling the camera unit to capture a second group of images when the camera unit is moving from the media position, determining one image from the second group of images as a next reference image, storing the next reference image into the storage system, and determining a next reference position of the electronic device where the camera unit captures the next reference image;
(e) repeating steps (b)-(c) upon condition that there are other reference images to be captured; and
(f) joining all reference images to generate a panoramic image according to a capture sequence of the reference images, and storing the panoramic image into the storage system.

14. The storage medium of claim 13, wherein the overlap area of the media image is 80% of the media image.

15. The storage medium of claim 13, wherein the camera unit comprises a shutter, wherein the shutter is configured to be pressed to start capturing the reference images and is configured to be pressed again to stop capturing the reference images.

16. The storage medium of claim 13, wherein in step (f), a last line of pixels of a specific reference image is joined to a first line of pixels of a reference image next to the specific reference image.

17. The storage medium of claim 13, wherein the media image is with an overlap area of a specified size with the reference image, and the media region is un-overlapped with the reference image.

18. The storage medium of claim 13, wherein the next reference image is overlapped with the media image, an overlap area of the next reference image is same as the media region.
